(19) United States
(12) Patent Application Publication
(10) Pub. No.: US 2025/0290669 A1
(43) Pub. Date: Sep. 18, 2025

(54) THERMOSTAT FOR A HOT WATER CYLINDER

(71) Applicant: POWEROPTIMAL (PTY) LTD, Kleinmond (ZA)

(72) Inventor: Andrew Peregrin GOEDHART, Kleinmond (ZA)

(21) Appl. No.: 18/861,142

(22) PCT Filed: Apr. 25, 2023
(86) PCT No.: PCT/ZA2023/050022

§ 371 Date: Oct. 28, 2024

(30) Foreign Application Priority Data
May 4, 2022 (GB) 2206504.9

(51) Int. Cl. F24H 15/223; F24H 9/20; F24H 15/128; H01H 47/26

(52) U.S. Cl. CPC F24H 15/223; F24H 9/2007; F24H 15/128; H01H 47/26

(57) ABSTRACT

A thermostat (100, 200, 300) is disclosed having input terminals (110, 152) and an output terminal (112). A load switch (114) for selectively connecting the input terminals to the output terminal is provided and comprises an electromagnetic relay configured to interrupt electrical connection between the input and output terminal when a coil (115) of the load switch is de-energized. The thermostat includes a temperature sensor (120), and a controller circuit (130) arranged to derive a temperature from the sensor. The controller circuit (130) is configured to selectively energize the coil (115) of the load switch (114) based on the temperature value to connect the input and output terminal. A thermal fuse (140) is provided and arranged to irreversibly de-energize the load switch coil (114) when the thermal fuse (140) is subjected to a temperature above a threshold to disconnect the input and output terminal.

### CROSS-REFERENCE TO RELATED APPLICATIONS

This application claims priority from United Kingdom patent application number 2206504.9 filed on 4 May 2022, which is incorporated by reference herein.

### FIELD OF THE INVENTION

The invention disclosed herein relates to thermostats and may find particular application with thermostats used to control the temperature of a hot water cylinder.

### BACKGROUND TO THE INVENTION

A thermostat is a device that is configurable to maintain temperature in the particular heating or cooling process at a selected temperature, or at least within a certain temperature range. In an electrical heating application, the thermostat is configured to supply electricity to a heating element if the measured temperature is below a lower threshold and to interrupt electricity supply to the heating element if the measured temperature is above an upper threshold. In an electrical cooling application, the thermostat is configured to supply electricity to a cooling system if the measured temperature is above an upper threshold and to interrupt electricity supply to the heating element if the measured temperature is below a lower threshold.

A well-known example of an electrical heating process is that of a hot water cylinder. The hot water cylinder will invariably be equipped with a thermostat to maintain the temperature of the water in the hot water cylinder at a selected temperature. Depending on the water temperature, the thermostat will connect or interrupt electricity supply to a heating element as required such that the water temperature will fluctuate around the selected temperature. Such thermostats are mostly electro-mechanical components relying on the principle of bi-metallic mechanical displacement-to open and close a set of contacts as the measured water temperature changes. Most residential hot water cylinders have a water-tight pocket into which a bi-metallic stem of a thermostat operatively extends. Thereby, the bi-metallic stem is in close proximity to the contents of the hot water cylinder allowing the thermostat to react to a change in water temperature.

As the water in the hot water cylinder cools or heats, the central rod of the bi-metallic stem contracts or expands, as the case may be. This enables a central rod in the stem to actuate a set of bi-metallic electrical contacts of the thermostat to open if the temperature acting on the stem exceeds a set temperature (disconnecting the electricity supply from the heating element), and close if the temperature acting on the stem falls below the set temperature (connecting the electricity supply to the heating element), thereby regulating the temperature within a temperature range around the set temperature.

Thermostats also have thermal safety cut-outs as fail-safe mechanisms in case of malfunction. These thermal safety cut-outs are configured to disconnect the electricity supply from the heating element in the event of overheating, possibly due to the thermostat's contacts having seized in the closed condition and resulting in uncontrollable heating of the water in the hot water cylinder. Typically, the thermal protection is performed by an actuator consisting of a bi-metallic element. If the stem is subjected to a temperature that exceeds a safety value, the resulting actuation of the bi-metallic stem causes a set of thermal protection contacts to irreversibly open, thereby irreversibly disconnecting the electricity supply to the heating element. Such an event necessitates human intervention, typically requiring the total replacement of the thermostat.

Hot water cylinders are known to be one of the greatest, if not the greatest, consumer of household electricity and can contribute as much as 50% of a household's electricity consumption. To combat this, various energy saving techniques relating to hot water cylinders have emerged. These techniques vary widely, from thermal insulation to the disconnection of power supply to the device, either manually or by means of a timer switch.

In recent years, particularly with the advent of the Fourth Industrial Revolution and the Internet of Things, the trend of integrating the hot water cylinder into the rest of the “smart home” has become a popular topic. To achieve such integration, an intelligent controller needs to interface with the hot water cylinder to measure water temperature and to enable control of the electricity supply to the heating element. Most, if not all of such “smart thermostats” at least partially depends on digital processing for its execution, likely by means of a microprocessor.

Referring back to the thermal safety cut-outs referred to above, it is a safety requirement (and widely also a regulatory requirement) for these thermal safety cut-outs to operate passively. In South Africa, thermostats for hot water cylinders must comply with South African National Standard (SANS) 181. SANS 181 requires, inter alia, that closed water heaters should incorporate a thermal cut-out that provides all-pole disconnection and that operates independently of the thermostat (although appliances intended to be connected to fixed wiring need not disconnect the neutral conductor).

That is to say that the operation of these safety mechanisms should not be dependent on the operation of a microprocessor for example, since the failure of the microprocessor could otherwise render the safety mechanism ineffective. For if the microprocessor were to cease executing with the relay in the closed condition, it would cause uncontrollable heating of the hot water cylinder, which could lead to a dangerous catastrophic failure. Accordingly, should a “smart thermostat” utilise a microprocessor-controlled relay to control the electricity supply to the heating element, it furthermore requires a passive thermal cut-out as an overriding failsafe.

In some jurisdictions, regulatory requirements may allow for the software-based operation of thermal safety cut-out mechanisms. However, the requirements as to the robustness and redundancy of such software-based mechanisms are very onerous and may cause the implementation thereof to become prohibitively expensive. Such systems would also be subject to regulatory testing and approval which may also be a time-consuming and expensive exercise and required on each revision of the system.

Furthermore, with the cost of photovoltaic panels having become within the reach of the consumer, residential solar hot water cylinder installations are becoming increasingly popular. Many households that are considering the transition to solar power for their hot water cylinders have existing electric hot water cylinders installed. Rather than replacing the existing electric hot water cylinder with a thermosiphon hot water system, for example, it may be less costly to retrofit the existing installation and directly power the electric hot water cylinder from a photovoltaic (PV) power source.

The contacts on thermostats used in mains-powered hot water cylinders are generally not suited for switching direct current (DC). The travel of the switching contact between its closed and open positions is generally in the order of about 2 millimetres. If this contact opens at an instant at which the mains supply voltage is around the zero-crossing, no arcing will occur across the opened contact. However, if the mains supply voltage at that instant is sufficiently high, an arc may form across the open contacts and will remain arcing until such time as the voltage again approaches the zero-crossing (in the order of about ±10V depending on the travel of the switching contact). This arcing increases contact wear and decreases the lifetime of the relay.

In the case of a DC supply, such as from a PV module, the contact will inevitably open on a non-zero voltage and, since the supply voltage would have no zero-crossing, the arc would endure until such time as the supply voltage is removed, falls below a certain voltage (e.g. when the incident sunlight on a PV module decreases), or when the switching contact fails catastrophically.

Consequently, a retrofit PV power supply on an electric hot water cylinder also typically requires an inverter to convert the DC output of the PV modules (often stored in battery banks) to an AC supply for which the thermostat is designed (i.e. mains voltage). The required capital expenditure is dramatically increased with the addition of the required inverter, battery banks, and charger components which places this technology out of the reach of many of the low- to medium-income households who would arguably benefit most from a PV-powered hot water cylinder.

Furthermore, with such a retrofit the mains supply may be completely disconnected and the hot water cylinder may not be provided with any backup power supply. Should unfavourable weather conditions persist, the hot water cylinder will run cold.

The Applicant is aware of European patent published as EP 2766 670 B1 (“EP'670”), which discloses power switching equipment for boilers including two contactors for selectively connecting a DC and an AC power supply to a load, the coils of which are both controlled by means of an alternating current (AC) power supply. EP'670 refers, in this regard, to live and neutral connections, which those skilled in the art understands to be a reference to a mains power supply (or utility power), such as a 230 V_{AC} or 120 V_{AC} mains supply. EP'670 further discloses a thermal fuse to protect against a thermostat failure. FIG. 1 in EP'670 reveals that the “thermal fuse” (marked “TP”) is in fact a set of normally closed dual-pole contacts (e.g. a dual-pole relay or contactor). If a pre-set temperature is reached, the normally closed contacts (“Y1” and “Y2” of “TP”) will open, thereby interrupting the AC power to the coils of the contactors. Since the coils of both contactors are controlled by means of AC power, as aforesaid, the equipment of EP'670 requires a persistent AC power supply connection.

The Applicant considers there to be room for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with this disclosure there is provided a thermostat comprising:
at least one set of input terminals for connecting an electric power source to the thermostat;
an output terminal for connecting the thermostat to a heating element;
a load switch for selectively connecting at least one of the set of input terminals to the output terminal and comprising an electromagnetic relay configured to interrupt electrical connection between the at least one set of input terminals and the output terminal when a coil of the load switch is de-energized;
a temperature sensor;
a controller circuit in communication with the temperature sensor and arranged to derive a temperature from a signal received from the temperature sensor, the controller circuit further being configured to selectively energize the coil of the load switch based on the derived temperature value in order to connect the at least one input terminal to the output terminal; and
a thermal fuse arranged to irreversibly de-energize the coil of the load switch coil when the thermal fuse is subjected to a temperature above a temperature threshold, thereby disconnecting a connection between the at least one set of input terminals and the output terminal.

These features may enable the thermostat to have an electronic temperature measurement and control mechanism, while the thermal safety cut-out is not under electronic control. This therefore prevents the possibility of the controller circuit failing or getting stuck in a state in which the load switch remains energized and therefore continuously provides power to a heating element. The thermal fuse irreversibly de-energizes the coil of the load switch, and is caused by an environmental factor, i.e. temperature, rather than electronic control (whether analog or digital).

De-energizing the coil of the load switch coil may comprise causing an open circuit of the electrical circuit comprising a source of the energizing signal and the load switch coil, additionally or alternatively disabling a source of the energizing signal. For example, if a dedicated direct current (DC) power supply is used to energize the load switch coil, the DC power supply may be turned off. This may be done by disconnecting an input power supply to the DC power supply, or by manipulating an enable/disable input on a switch mode power supply component.

The thermostat may be a stem-type thermostat comprising a housing and an elongate hollow stem extending from the housing, wherein the temperature sensor and the thermal fuse are located internally to and near a distal end of the stem.

The low voltage and current rating of the load switch coil enable the thermal fuse and wiring to be small enough to be positioned inside the stem. The use of mains-rated voltage coils, for example, would necessitate a thermal fuse and wiring physically large enough to handle such high voltages. Similarly, the use of a thermal fuse to break (high) load-currents (rather than low coil currents) would also necessitate a large thermal fuse and wiring. In both such cases, the thermal fuse and wiring would be prohibitively large for placement inside the stem.

These features may enable the thermostat to be used with a hot water cylinder designed to be used with a conventional bi-metallic stem-type thermostat. The temperature sensor and thermal fuse being located towards a distal end of the stem may promote more accurate sensing and/or fusing of the thermal fuse at its rated temperature. This is so, since during use they will be positioned deeper within the stem pocket, and thus deeper within the hot water cylinder. The features of the thermal fuse being arranged to de-energize the coil, as opposed to breaking of high load currents, enable the thermal fuse to be placed within the stem. This is due to the currents to the switch coils being much lower than the rated load currents, requiring thinner conductors. Using the thermal fuse to break the load current would require wires that are too thick to fit within the internal diameter of the stem.

The at least one set of input terminals of the thermostat may comprise a first set of input terminals for connecting a first electric power source to the thermostat, and may further include a first source switch comprising an electromagnetic relay and having contacts interposed between the first set of input terminals and the contacts of the load switch, the first source switch being configured to interrupt the electrical connection to the first set of input terminals when a coil of the first source switch is not energized, wherein the thermal fuse is arranged to irreversibly de-energize the load switch coil as well as the first source switch coil when the thermal fuse is subjected to a temperature above a temperature threshold, thereby causing the contacts of both the load switch and the first source switch to be returned to an open position. The coil of the first source switch may be rated for use with the same voltage as that of the load switch.

The first power source may be an alternating current (AC) power source, such as mains power. The first source switch may have at least two co-operating switch contacts, such that energizing and de-energizing its coil respectively connects and disconnects all poles of the first power source.

In one embodiment, the at least one set of input terminals of the thermostat may further comprise a second set of input terminals for connecting a second electric power source to the thermostat, and may further include a second source switch comprising an electromagnetic relay configured to selectively connect either the contacts of the first source switch, or the second set of input terminals to the contacts of the load switch, the second source switch being arranged to connect the contacts of the first source switch to the contacts of the load switch when a coil of the second source switch is de-energized, and wherein the thermal fuse is arranged to irreversibly de-energize the load switch coil, the first source switch coil, and the second source switch coil when the thermal fuse is subjected to a temperature above a temperature threshold. The coil of the second source switch may be rated for use with the same voltage as that of the load switch.

In another embodiment, the at least one set of input terminals may further comprise a second set of input terminals for connecting a second electrical power source to the thermostat, and may further include a second source switch comprising an electromagnetic relay configured to selectively connect either the first set of input terminals, or the second set of input terminals to the contacts of the first source switch, the second source switch being arranged to connect the first set of input terminals to the contacts of the first source switch when a coil of the second source switch is de-energized, and wherein the thermal fuse is arranged to irreversibly de-energize the load switch coil, the first source switch coil, and the second source switch coil when the thermal fuse is subjected to a temperature above a temperature threshold, wherein the coil of the second source switch is rated for use with the same voltage as that of the load switch.

These features may enable a thermal fuse failure event to cause all the switches to return to an at-rest configuration, in which there is effectively an all-pole disconnect of both the first and the second power source.

The second power source may be a direct current (DC) power source, such as a photovoltaic (PV) power source.

The coil of the load switch, first source switch, and second source switch may have the same voltage rating. The thermostat may further include a power supply unit arranged to output an energizing voltage corresponding to the voltage rating of the coils from either or both of the first power source and the second power source. De-energizing the coils may comprise causing an open circuit of the electrical circuit comprising the output of the power supply and the coils.

The controller circuit may further include a power source selecting component arranged to selectively energize the coils of the first source switch and the second source switch, thereby to selectively connect either the first or the second power source to the contacts of the load switch.

These features may enable the thermostat to power the heating element selectively, possibly based on availability of either or both of the power sources. For example, in embodiments in which the second power source is a PV power source, the power source selecting component may be utilized to switch to the first power source (possibly AC mains) during low light conditions or inclement weather conditions.

The thermostat may furthermore include an arc preventing component arranged to reduce or prevent arcing of the load switch contacts. The arc preventing component may include an AC zero-crossing detecting component arranged to cause switching of the load switch contacts during or near the zero-crossing of the power source when an AC power source is selected by the power source selecting component. The arc preventing component may further include a DC short-circuiting component arranged to momentarily short-circuit the power source before the load switch contacts are opened when a DC power source is selected by the power source selecting component.

These features may reduce arcing by only switching the load switch contacts near the zero-crossing when an AC source is selected. At such low voltage, an arc is prevented from forming or is sustained only for a short duration, at most until the zero-crossing. These features may also reduce or prevent arcing by momentarily short-circuiting a DC source when selected before opening the load switch contacts. This causes the DC source voltage to become zero, or near-zero, thereby causing zero or a small load current to flow, which does not cause or sustain an arc when the load switch contacts open. These features may extend the life of the load switch.

The coil of the load switch may be rated for use with a direct current (DC) voltage of 60V or less, or an alternating current (AC) voltage having an amplitude of 60V or less.

An embodiment of the invention will now be described, by way of example only, with reference to the accompanying drawings.

### BRIEF DESCRIPTION OF THE DRAWINGS

In the drawings:

FIG. 1 is a schematic representation of a first embodiment of a thermostat in use with a hot water cylinder and powered by a power source;

FIG. 2 is a schematic representation of a second embodiment of a thermostat in use with a hot water cylinder and connected to two power sources;

FIG. 3 is a schematic representation of a third embodiment of a thermostat in use with a hot water cylinder and connected to two power sources;

FIG. 4 is a schematic representation of a circuit comprising an energizing voltage, coils of various electromagnetic relays of a thermostat, and a thermal fuse arranged to irreversibly de-energize the coils upon an overtemperature event;

FIG. 5 is a schematic representation of an alternate circuit comprising an energizing voltage, coils of various electromagnetic relays of a thermostat, and a thermal fuse arranged to irreversibly de-energize the coils upon an overtemperature event;

FIG. 6 is a schematic representation of a power supply unit of a thermostat and its arrangement with the circuit of FIG. 5;

FIG. 7 is a schematic representation of a stem-type thermostat in use with a hot water cylinder, showing an enlarged view of a distal end of its stem with hidden detail;

FIG. 8 is a block diagram showing functional units of a controller circuit of a thermostat;

FIG. 9 is a graph showing a zero-crossing envelope of an AC power source; and

FIG. 10 is the thermostat of FIG. 2 further including a schematic representation of a DC short-circuiting component.

### DETAILED DESCRIPTION WITH REFERENCE TO THE DRAWINGS

Embodiments of a thermostat are described below. The thermostat may have at least one set of input terminals for connecting an electric power source to the thermostat. The input thermals may be screw terminals suitably rated in terms of current-carrying capacity, creepage and clearance. In some embodiments, an AC mains power supply may be connected to the input terminal. The thermostat further includes an output terminal for connecting the thermostat to a heating element, typically of a hot water cylinder having similarly suitable ratings.

The thermostat includes a load switch, an electromagnetic relay, thus having a coil and a set of contacts that selectively open and close based on whether the coil is energized. The load switch has a normally open contact or normally open contacts in embodiments with a multi-pole single throw load switch (e.g., a double pole single throw). In embodiments in which the load switch has a single normally open contact, the load switch is typically arranged to break or connect a power supply to the output terminal (and thus to a heating element if connected) on the supply side, rather than on the return side. In embodiments in which a double pole single throw load switch is used having normally open contacts, the connection to the output terminals (and thus to any heating element connected thereto) is interrupted on all poles. As the load switch is normally open, the load switch is configured to interrupt electrical connection between the at least one set of input terminals and the output terminal when its coil is de-energized.

The thermostat further includes a temperature sensor. A digital temperature sensor is preferable, such as a DS18B20 (from Maxim Integrated™), having a 1-Wire digital communication interface and providing a digital temperature readout with checksum values for error-checking. In some embodiments, the temperature sensor may be a passive component, such as a thermistor, which may require a further analogue chain and a digitizing stage to obtain a digital temperature value. In some embodiments, an analogue signal obtained from the temperature sensor may be utilized.

The thermostat further includes a controller circuit in communication with the temperature sensor and arranged to derive a temperature from a signal received from the temperature sensor. In embodiments in which the controller circuit includes digital processing, it may include a microprocessor arranged to communicate with the digital temperature sensor via a digital communication interface (such as 1-Wire, I2C, etc.). Where a passive temperature sensor is used, an on-board analogue-to-digital converter (“A2D”) may be used to obtain a digital temperature value. Alternatively, and external A2D component may be interposed between the microprocessor and the passive temperature sensor. In embodiments in which the control circuit is analogue, a suitable analogue chain comprising amplifiers, filters, and comparators (preferably with hysteresis), may be utilized.

The controller circuit is configured to selectively energize the coil of the load switch based on the derived temperature value in order to connect the at least one input terminal to the output terminal. A suitable electronic switch, such as a transistor, may be utilized to selectively connect or disconnect an energizing voltage (or current) to and from the coil of the load switch. The electronic switch may, for example, be a bipolar junction transistor (BJT) or a field effect transistor (FET).

The thermostat further includes a thermal fuse, sometimes also referred to as a “thermal link”, arranged to irreversibly de-energize the coil of the load switch coil when the thermal fuse is subjected to a temperature above a temperature threshold, thereby disconnecting an electrical connection between the input terminal or terminals and the output terminal (and thus to any load, i.e. heating element, connected to the output terminals).

The thermostat may be a stem-type thermostat comprising a housing (housing the input terminal(s), output terminals, controller circuit, etc.) and an elongate hollow stem extending from the housing. The stem should be of a heat-conductive material such as copper. The temperature sensor and the thermal fuse are located inside the hollow stem at or near a distal end, and connected to the components in the housing with wires.

The operating principle of thermal links is based on the concept that the thermal element will melt and shut off the electrical current in the event of the ambient temperature reaching a hazardous level. In the context of this specification, and with reference to the technology disclosed herein, the terms “thermal fuse” or “thermal link” refer to an electrical component that conducts current under normal circumstances and having a thermal element that melts in the event of an over-temperature event, thereby causing an open circuit and preventing current from conducting therethrough.

An exemplary, high current-rated variant uses a thermal pellet placed inside a metal case and is designed to trigger a cut-off function in response to an abnormal temperature situation. Due to the high current rating, this variant may have a larger casing (around 4 mm in diameter) and thicker leads (about 1 mm thick), making it unsuitable for fitting inside the hollow stem when used in conjunction with the wiring required to carry the higher current.

An exemplary, low current-rated variant utilizes a fusible inside a casing. This variant may have a much smaller casing (e.g. 1.6 mm) and thinner leads (about 0.5 mm), enabling it to be used inside the hollow stem.

As aforementioned, utilizing a low-current variant of the thermal fuse enables it to be located inside the stem and, preferably, as far as possible toward the outer tip (the distal end) of the stem. A first effect of having the thermal fuse located toward the outer tip of the stem is that the thermal fuse will, during use, be deeper into the hot water cylinder and thus as close to the actual temperature of the water as possible. For the same reason, it is preferable to also have the temperature sensor in the same position, i.e. inside the stem, as far as possible towards the outer tip. However, with the space inside the stem being very little, it leaves little space for all the conductors required to and from both the temperature sensor as well as the thermal fuse.

This is why it is advantageous for the thermal fuse to cause a break in the energizing signal to the coil of the load switch, rather than a break in the conductors of the load current. The current of the coil energizing signal is much lower (in the order of milliamperes) when compared with the several amperes of the load current and therefore only requires relatively thin conductors to and from the thermal fuse. This enables the temperature sensor, the thermal fuse, and their conductors to be placed inside the hollow stem. If a high current-rated variant is used, the conductors required to carry the load current would be prohibitively thick.

Furthermore, the thermal fuse is arranged in the circuitry so as to operate, not only with low current, but at low voltages as well. The coils of the switch or switches that the thermal fuse is arranged to irreversibly de-energize (when the thermal fuse is subjected to a temperature above a temperature threshold) may therefore be rated to operate at a low DC voltage such as 5V or 12V. The combination of a thermal fuse arranged to perform its function in a low current, low voltage section of the circuitry may be advantageous as it enables the size of the thermal fuse and the wiring to be selected to be small enough to fit inside the stem as aforesaid. A low current, but (relatively) high voltage application may still require a physically larger thermal fuse rated for the high voltage. Hence, the combination of low voltage and current may be preferred.

Requirements often dictate that the thermal safety features of the thermostat must not be dependent on electronic control, particularly software control. This may cause catastrophic, dangerous failure if a microcontroller fails, or if its firmware gets stuck in an infinite loop, while the coil of the load switch is energized and the load switch contacts are closed. Having the thermal fuse interrupt the energizing signal to the coils achieves returning the thermostat to a non-powering state, entirely outside the control of any electronics.

In some embodiments, the thermostat may be a dual-supply thermostat. That is to say that two different power sources may be connected to the thermostat, and the two power sources selectively being used depending on operational conditions and requirements.

In such embodiments, the thermostat may have a first source switch, also an electromagnetic relay. The first source switch preferably has multiple poles, a pole for each connection, conductor, or terminal of the relevant power source. For an AC mains power source consisting of a live and a neutral connection, the first source switch therefore should be a normally open double pole single throw relay, such that both contacts switch in unison, and such that all the poles of the power source are disconnected when the first source switch is in a de-energized state.

The first source switch's contacts are interposed between the first input terminals and the load switch. This should be understood to be interposed in an electrical sense, in that the first source switch is operable to switch the power source through to the contacts of the load switch which, in turn, is operable to switch the power source through to the load.

In such embodiments, the thermostat may further include a second set of input terminals. It is envisaged that, in some embodiments, the first power source (connectable to the first set of input terminals) may be mains AC (e.g. 240 V_{AC} at 50 Hz), and the second power source (connectable to the second set of input terminals) may by a DC power source, possibly from a PV power source. However, both first and second power sources may be AC (the one mains, the other perhaps a PV power source after an inverter stage).

In such embodiments, the thermal fuse is configured to irreversibly de-energize the coils of the load switch, the first source switch, and the second source switch when the thermal fuse is exposed to a temperature (inside the hot water cylinder) exceeding its rated operating temperature. This returns the thermostat to a non-powering state, disconnecting both the load, as well as all poles of both power sources. This therefore introduces a redundancy in that if, for some reason, the load switch contacts remain closed (e.g. due to the contacts having become fused for some reason) the first and second source switches serve to disconnect the power sources. The first source switch and second source switch may be referred to below collectively as “the source switches”.

The coils of the load switch and the source switches may be connected in various configurations. For example, they may be connected in parallel and switched with a common electrical switch (such as a BJT or FET). With an NPN BJT, one side of each of the coils may be connected to an excitation power source, e.g. a DC voltage of 5V or 12V, depending on the coil ratings. Ideally, the load switch and source switches should have coils with the same rating (e.g. DC 12V), with the other side of the coils being connected to the collector of the BJT, which switches each of the coils during operation. Multiple BJT's may also be used, with each coil connected to a separate BJT, with the same signal being used to drive the bases of the respective BJT's during use.

An alternative configuration for de-energizing the coils of the load switch and the source switches is disabling the power supply from which the energizing signal (e.g. 12 V_{DC} or 5 V_{DC}) is obtained, provided that the disabling is effected at low voltage and current levels. Many voltage regulators or switch mode power supply (PSU) integrated circuits (IC's) have an enable/disable input. For example, the switch mode PSU IC may have an enable line that must be pulled to ground to enable its regulated output. In such a configuration, the thermal fuse may be connected between the enable/disable input of the switch mode PSU and ground. A pull-up resistor may be connected between the enable/disable input and low voltage (e.g. 5V). Should an over-temperature event occur and the thermal fuse break, the enable input will be pulled up, thereby disabling the output and, in turn, disabling the energizing signal (i.e., the regulated output voltage of the switch mode PSU).

To make provision for one of the sources being a DC power source, it may be preferable for the load switch to be selected such that its contacts are DC-rated, as DC is more taxing on the contacts than AC. This may enable the load switch to switch either an AC or DC power source.

The second source switch is preferably double-pole double-throw (DPDT) relay, with the same coil rating as that of the first source switch and the load switch. The DPDT contacts enable at least two features. Firstly, the dual poles enable both conductors of the second power source to be disconnected. Secondly, it enables the second power supply to be connected to the normally open contacts, and the first supply switch's output (i.e. the switched side of the contacts, as opposed to the “hot” side) to be connected to the normally closed contacts of the second source switch. The common terminal of the second source switch then connects to the load switch. This serves as a mutually-exclusive selector switch between the first and second power source.

It will be appreciated that various configurations of the three coils (i.e. the coils of the load switch, first source switch, and second source switch) may be achieved to de-energize them simultaneously in response to the fusing of the thermal fuse, mutatis mutandis as explained above.

In dual-source embodiments, the controller circuit of the thermostat further includes a power source selecting component arranged to selectively energize the coils of the first source switch and the second source switch, thereby to selectively connect either the first or the second power source to the contacts of the load switch.

Furthermore, in dual-source embodiments, the thermostat also includes an arc preventing component arranged to reduce or prevent arcing of the load switch contacts. As aforementioned, DC is more taxing on contacts as opening the contacts inevitably occur while current flows through the contacts. In the case of AC, the power supply passes through zero again at the most 10 ms after switching for a 50 Hz mains source. Ideally, an AC source should also be switched close to the zero-crossing. The arc preventing component may include an AC zero-crossing detecting component arranged to cause switching of the load switch contacts during or near the zero-crossing of the power source when an AC power source is selected by the power source selecting component. Therefore, should conditions require the load switch contacts to open with an AC power source selected, the arc preventing component will monitor or sample the source voltage and time the opening of the load switch contacts to occur near the zero-crossing.

The arc preventing component further includes a DC short-circuiting component arranged to momentarily short-circuit the power source before the load switch contacts are opened when a DC power source is selected by the power source selecting component. This causes the DC source voltage to become zero volt, or near-zero volt, for a short interval thereby causing zero or a small load current to flow through the switch contacts. Opening the load switch contacts during this interval therefore prevents or at least reduces an arc. These features may extend the life of the load switch. A typical DC relay without an arc preventing component may be rated for, say, 10,000 cycles (switched at load). However, a thermostat may require a capability of 50,000 cycles. The arc preventing component may, in the manner as explained above, considerably increase the lifetime or cycle rating, since the contacts will not be subjected to the usual arcing associated with switching full load DC current.

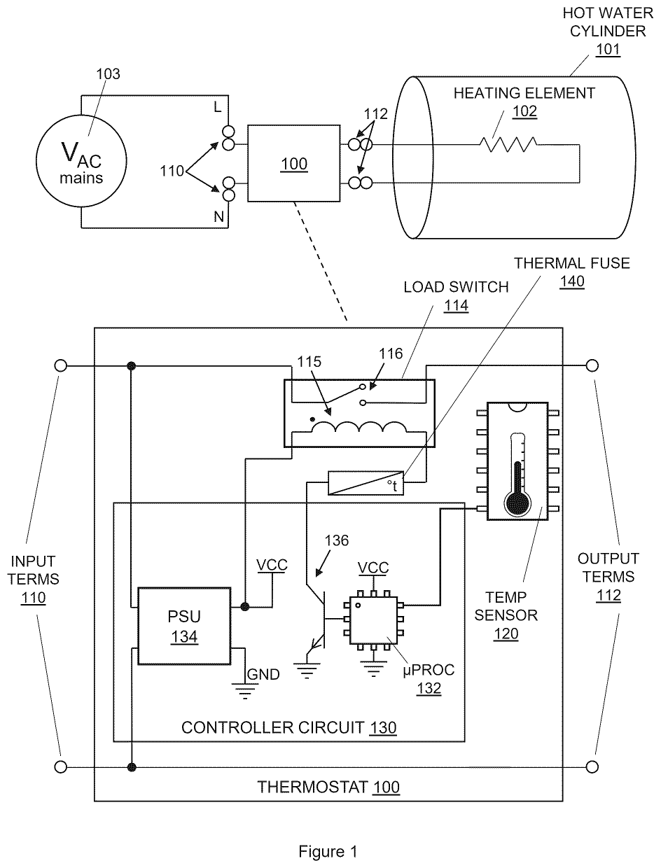

FIG. 1 shows a first embodiment of a thermostat (100). FIG. 1 shows an overview schematic with the thermostat (100) in use with a hot water cylinder (101) which has an internal heating element (102). In this embodiment, the thermostat (100) is configured to be powered from a 50 Hz 240 V_{AC} power source (103).

FIG. 1 also shows a detail schematic view of the thermostat (100). The thermostat (100) has a set of (first) input terminals (110) for connecting the power source (103) to the thermostat (100). The thermostat (100) further includes an output terminal (112) for connecting the thermostat (100) to the heating element (102) of the hot water cylinder (101).

The thermostat (100) includes a load switch (114). The load switch (114) is an electromagnetic relay having a coil (115) and a set of normally open contacts (116). The load switch (114) is arranged to selectively make or break an electrical connection between the input terminals (110) (and thus the power supply (103) and the output terminals (112) (and thus the heating element (102). With the load switch (114) contacts (116) being normally open, the connection is broken when its coil (115) is de-energized.

The thermostat further includes a temperature sensor (120) arranged to measure a temperature of the water of the hot water cylinder (101). The thermostat (100) further includes a controller circuit (130) in communication with the temperature sensor (120) and arranged to derive a temperature from a signal received from the temperature sensor. The controller circuit (130) includes a microprocessor (132) arranged to communicate with the temperature sensor (120) and obtain a temperature value.

The controller circuit (130) is configured to selectively energize the coil (115) of the load switch (116) based on the derived temperature value. If a set water temperature for the hot water cylinder (101) is, for example, 50° C., the controller circuit (130) may energize the coil (115) when measuring a temperature below 50° C. (e.g. 48° C. or less), and may de-energize the coil (115) when measuring a temperature above 50° C. (e.g. 52° C. or more). This may provide a hysteresis to prevent relay chatter.

A power supply unit (PSU) (134) provides an energizing signal (VCC), which is connected to one end of the coil (115). The other end of the coil (115) is connected to the collector of an NPN BJT (136) via a thermal fuse (140). The base of the BJT (136) is connected to an output of the microprocessor (132), and the output of the microprocessor is operable to energize the coil (115) by turning on the BJT (136). The thermal fuse (140), being connected in series between the coil (115) and the BJT (136) will irreversibly interrupt the flow of current through the coil (115) regardless of the state of the BJT (136) if an over-temperature fuse event occurs.

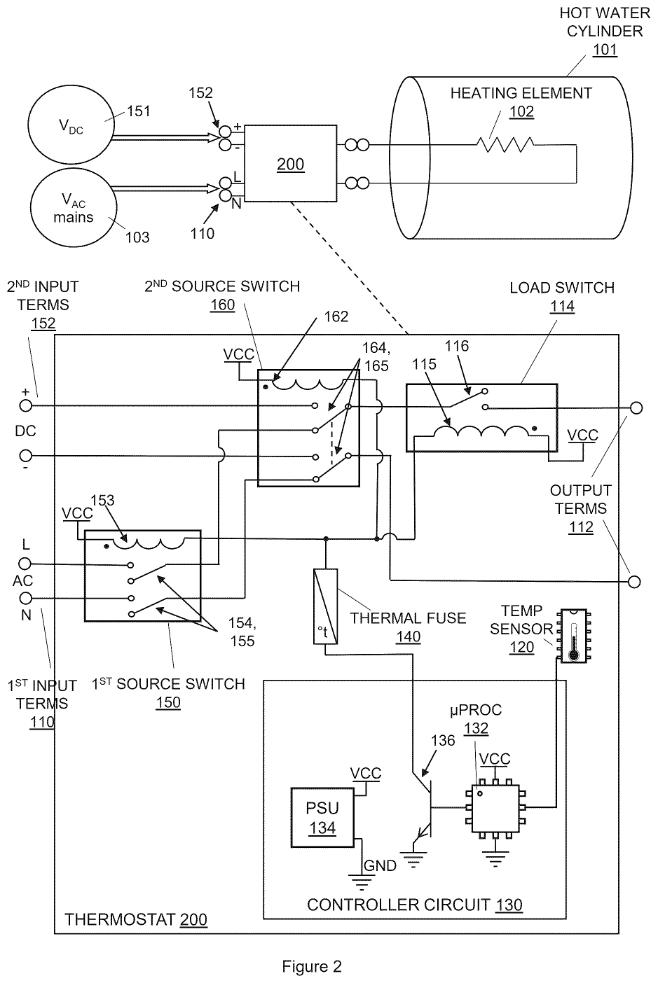

FIG. 2 shows a second embodiment of a thermostat (200). Where the same reference numerals are used in FIG. 2 as before, it indicates the same, equivalent or substantially similar feature or component. In this embodiment, the thermostat (200) is a dual-supply thermostat, capable of being powered by both an AC mains power supply (103), or a DC power supply (151), or both. The thermostat (200) further includes a source switch, referred to here as the “first source switch (150)” in order to differentiate it from components of the thermostat (200) described further below. The first source switch (150) is also an electromagnetic relay having a coil (153). However, the first source switch (150) is a double pole single throw (DPST) relay, having two cooperating normally open contacts (154, 155). Each pole of the input terminals (110) (and in turn the live and neutral of the power source (103)) connect to a respective pole (154, 155) of the first source switch (150) on the “hot” side. The switched side of the first source switch (150) contacts (154, 155) connect to the “hot” side of the load switch (114).

When the first source switch's coil (153) is energized, the contacts (154, 155) switch in unison and, conversely, are disconnected in unison when the in a de-energized state.

The energizing voltage (VCC) of the PSU (134) is also connected to one side of the first source switch coil (153). The other side thereof is connected to the base of the BJT (136), and is therefore connected in parallel with the load switch coil (115) and controllable with the same BJT (136).

The thermostat (200) includes a second source switch (160), also an electromagnetic relay. The second source switch (160) is double-pole double-throw (DPDT) relay, with its coil (162) having the same coil rating as that of the coil (153) of the first source switch and that of the load switch (115). The DPDT contacts (164, 165) enable both conductors of the DC power supply (151) to be disconnected. It also enables the DC power supply (151) to be connected to the normally open contacts, and the output of the first source switch (150), (i.e. the AC power on the switched side of the contacts) to be connected to the normally closed contacts of the second source switch (160). The common terminal of the second source switch (160) then connects to the load switch (114). This serves as a mutually-exclusive selector switch between the DC and AC power sources (151, 103).

The thermal fuse (140) is connected in series between the BJT (136) and the coils (115, 153, 162). Therefore, the thermal fuse (140) will irreversibly interrupt the flow of current through each of the coils (115, 153, 162) regardless of the state of the BJT (136) if an over-temperature fuse event occurs. This returns the thermostat to a non-powering state, disconnecting the heating element (102), as well as all poles of both the power supplies (103, 151).

This therefore introduces a redundancy. If, for some reason the load switch contacts (116) remain closed (e.g. due to the contacts having become fused for some reason) the first power source switch (150) and second power source switch (160) serve to, in concert, disconnect the power sources (103, 151).

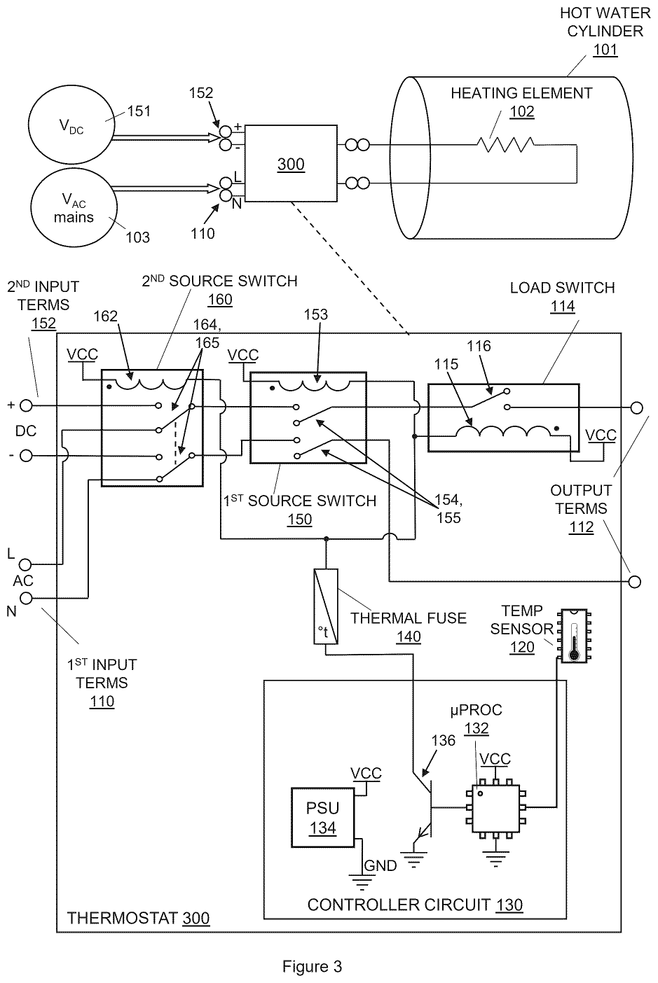

FIG. 3 shows a third embodiment of a thermostat (300). Where the same reference numerals are used in FIG. 3 as before, it indicates the same, equivalent or substantially similar feature or component. In this embodiment, the thermostat (300) is also a dual-supply thermostat, capable of being powered by both an AC mains power supply (103) or a DC power supply (151), or both.

The thermostat (300) also includes the first source switch (150), as well as the second source switch (160), but with both in a different configuration than in FIG. 2. In this embodiment, the first source switch (150) is interposed between the second source switch (160) and the load switch (114), with the “hot” side of the first source switch contacts (154, 155) being connected to the switched side of the second source switch contacts (164, 165). On the switched side of the first source switch contacts (154, 155), the one of the first source switch contacts (154) is connected to the “hot” side of the load switch contact (116), with the other first source switch contact (155) being directly connected to one of the output terminals (112).

Each pole of the input terminals (110) (and in turn the live and neutral of the power source (103)) connect to a respective pole (154, 155) of the first source switch (150) on the “hot” side. The switched side of the first source switch (150) contacts (154, 155) connect to the “hot” side of the load switch (114).

The second source switch (160), being a double-pole double-throw (DPDT) relay, has its normally closed contacts connected to the first in put terminals (110) and thus to an AC power source when connected to the thermostat (300). The normally open contacts of the second source switch (160) are connected to the second set of input terminals (152) and thus to a DC power source when connected to the thermostat (300). The common terminal, or switched side, of the second switch's contacts (164, 165) are connected to the first source switch contacts (154, 155) as aforesaid. At rest, i.e. when the coil (162) of the second source switch (160) is not energized, the second source switch therefore selects the first input terminals (110) as its input power source. By energizing the coil (162) of the second source switch (160), the DC power source may be selected as input power source. This serves as a mutually-exclusive selector switch between the DC and AC power sources (151, 103).

In this embodiment, the thermal fuse (140) is also connected in series between the BJT (136) and the coils (115, 153, 162). Therefore, the thermal fuse (140) will irreversibly interrupt the flow of current through each of the coils (115, 153, 162) regardless of the state of the BJT (136) if an over-temperature fuse event occurs. This returns the thermostat to a non-powering state, disconnecting the heating element (102), returns the second source switch (160) to having the AC power source as its input, and also disconnects all the poles by means of the first source switch (150) returning to its normally open state.

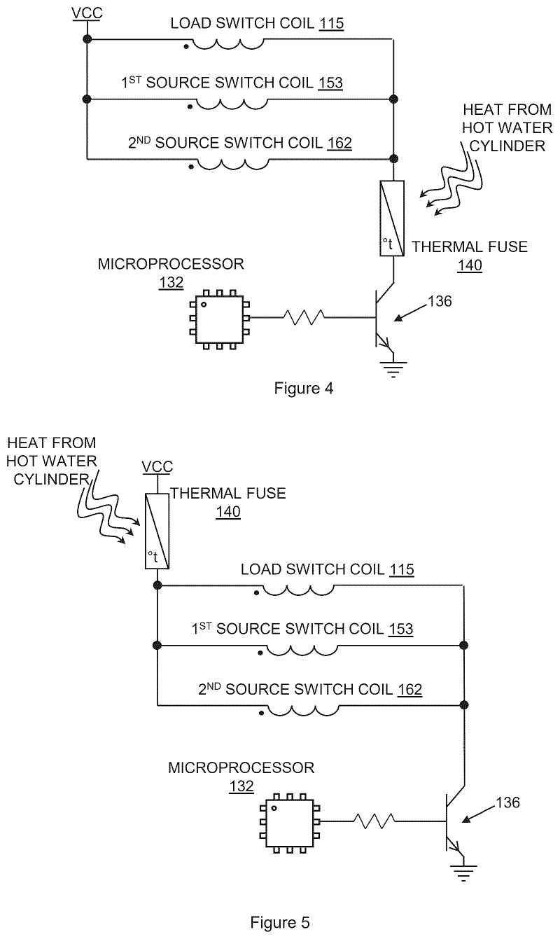

It will be appreciated that various configurations of the three coils (115, 153, 162) (i.e. the coils of the load switch, first source switch, and second source switch) may be achieved to de-energize them simultaneously in response to the fusing of the thermal fuse. A selection of such variations is illustrated schematically in FIGS. 4 to 6.

FIG. 4 shows the three coils (115, 153, 162) connected in parallel, with one end of each being connected to the energizing voltage (VCC), and the other being connected to the BJT (136) via the thermal fuse (140). Should the thermal fuse (140) experience an overheat condition due to the heat from the hot water cylinder (101), it will break the circuit, thereby de-energizing all three coils (115, 153, 162).

FIG. 5 shows the three coils (115, 153, 162) connected in parallel, with one end of each being connected to the energizing voltage (VCC) via the thermal fuse (140), and the other being connected to the BJT (136). Should the thermal fuse (140) experience an overheat condition due to the heat from the hot water cylinder (101), it will disconnect the energizing voltage (VCC), thereby de-energizing all three coils (115, 153, 162). The configuration of FIG. 5 may be a preferred arrangement over that of FIG. 4. If, for some reason, the thermal fuse (140) short-circuits to ground, the arrangement of FIG. 4 would be capable of sustaining (uncontrollable) current flow through the coils. However, the same short-circuit in the arrangement of FIG. 5 would cause the coils (115, 153, 162) to be de-energized, and returning the thermostat to an unpowered state.

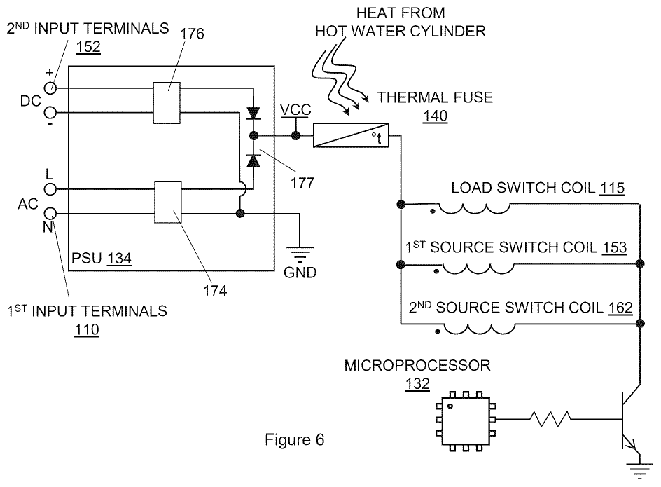

FIG. 6 shows an arrangement with dual supplies, i.e. the AC mains power source (103) as well as the DC power source (151). The PSU (134) receives both power supplies and obtains the energizing voltage (VCC) from one of them. In the “AC branch” of the PSU (134), the mains may be stepped down, rectified and regulated by circuitry (174) as is known in the art.

In the “DC branch” of the PSU (134), the DC input may be regulated at the same or similar output voltage by circuitry (176) as is known in the art. An “OR” arrangement (177) may be used to obtain an energizing voltage (VCC). The remainder of FIG. 5 shows an arrangement similarly to FIG. 4, in which the coils (115, 153, 162) are connected in parallel with one side connected to the energizing voltage (VCC) via the thermal fuse (140).

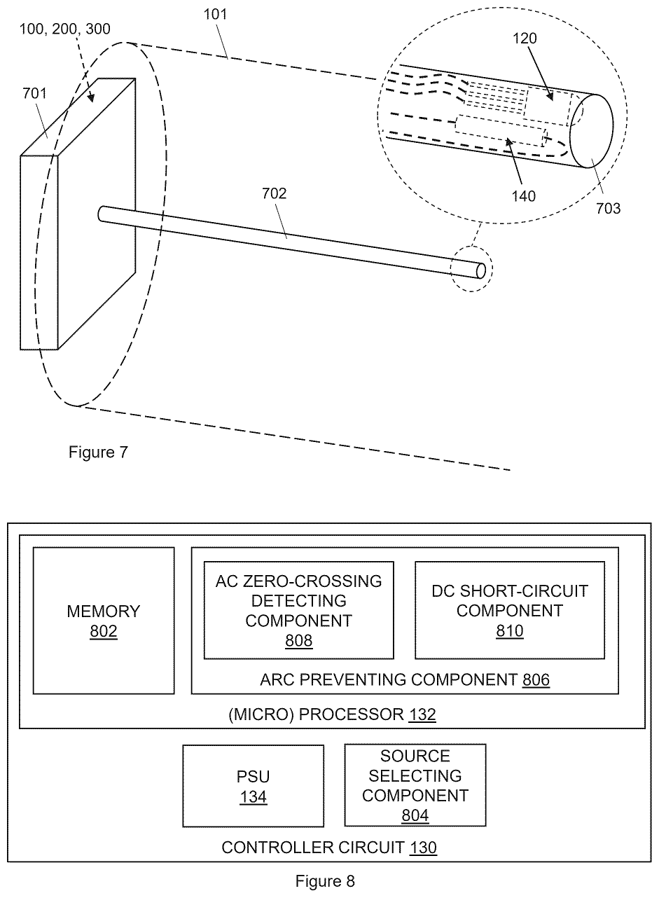

FIG. 7 illustrates an installation of the thermostat (100, 200, 300) in a hot water cylinder (101). The thermostat (100, 200, 300) is a stem-type thermostat comprising a housing (701) and an elongate hollow copper stem (702) extending from the housing. The majority of the components of the thermostat (100, 200, 300) may be housed in the housing (701). As shown in the hidden detail enlarged view in FIG. 7, the temperature sensor (120) and the thermal fuse (140) may be located inside the stem (702) at a distal end (703) thereof. Utilizing the thermal fuse (140) to break the relatively small coil currents, rather than using it to break the relatively large load currents, enable a physically small thermal fuse (140) to be used as well as thinner conductors. This enables it to be fit inside the stem (702) alongside (or at least near) the temperature sensor (120).

FIG. 8 is a block diagram illustrating functional components of the controller circuit (130). FIG. 8 shows the microprocessor (132), which includes a memory (802) for storing and retrieving instructions and variables. The functions of components described below, may be provided by hardware or by software units executing on the controller circuit (130). The software units may be stored in the memory (802) and instructions may be provided to the microprocessor (130) to carry out the functionality of the described components.

The controller circuit (130) includes a source selecting component (804) arranged to selectively energize the coils (153, 162) of the first source switch (150) and the second source switch (160), thereby to selectively connect either the AC power source (103) or the DC power source (151) to the contacts (116) of the load switch (114).

The controller circuit (130) includes an arc preventing component (806) arranged to reduce or prevent arcing of the load switch contacts (116). The arc preventing component includes an AC zero-crossing detecting component (808) arranged to cause switching of the load switch contacts (116) during or near the zero-crossing of the AC power source (103), when that is selected by the power source selecting component. Therefore, should conditions require the load switch contacts (116) to open with the AC power source (103) selected, the arc preventing component (806) will monitor or sample the source voltage and time the opening of the load switch contacts (116) to occur near the zero-crossing.

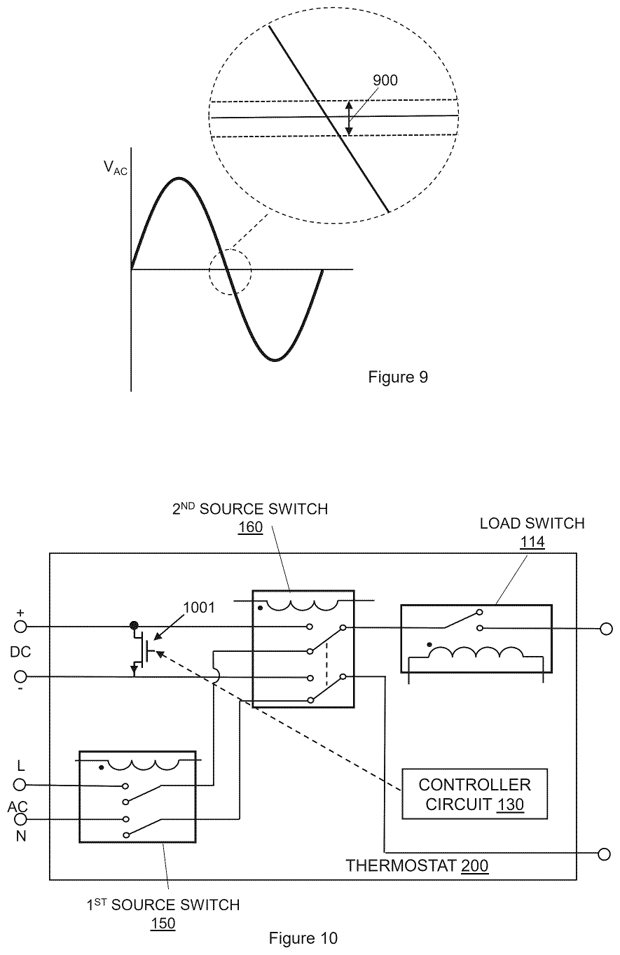

FIG. 9 shows an envelope (900) in broken lines about the zero crossing of the AC power source (103) voltage within which the arc preventing component (806) will cause switching will be performed.

Returning to FIG. 8, the arc preventing component (806) further includes a DC short-circuiting component (810) arranged to momentarily short-circuit the DC power source (151) before the load switch contacts (116) are opened when the DC power source is selected by the power source selecting component (804). This causes the DC source voltage to become zero volt, or near-zero volt, for a short interval thereby causing zero or a small load current to flow through the load switch contacts (116). Opening the load switch contacts during this interval therefore prevents or at least reduces an arc.

FIG. 10 shows an embodiment of the thermostat (200) in which a FET (1001) is connected between the inputs of the DC power source (151). The FET (1001) is operable by the controller circuit (130) to momentarily short-circuit the DC power source as aforesaid, to prevent arcing.

The arc preventing component (806) and its sub-components may extend the life of the load switch (114). A typical relay with a DC-rated contact may be rated for, say, 10,000 cycles (switched at load). However, a thermostat may require a capability of 50,000 cycles. The arc preventing component (806) may, in the manner as explained above, considerably increase the lifetime or cycle rating, since the contacts will not be subjected to the usual arcing associated with switching full load DC current. It will be appreciated by those skilled in the art that embodiment of the thermostat (300) of FIG. 3 may similarly include a FET (1001) between the inputs of the DC power source (151), and configured to be utilised as aforesaid.

Embodiments of thermostats are therefore provided that have a form-factor enabling its use as replacement parts for conventional stem-type bi-metallic thermostats. A dual-supply thermostat is provided, which enables selective use of an AC and a DC power supply. And the various thermal fuse configurations explained above enable thermal fail-safe mechanisms without requiring a bulky bi-metallic thermal interrupter, and which are not under programmatic or electronic control and thus satisfy regulatory requirements in this regard. The configurations with multiple relays also provide protection redundancy. The embodiments of the thermostat further provide for all-pole disconnection of power sources, as may also be required by regulation. Arc-prevention mechanisms extend the life (switching cycles) of the load switch.

Embodiments of thermostats disclosed herein also enable their use in controlling and powering a single load (i.e. a single heating element) selectively between two different power sources.

The low voltage and current rating of the load switch coil, as well as the coils of the source switches, enable the thermal fuse and wiring to be small enough to be positioned inside the stem of a stem-type thermostat. This enables the thermal fuse to be placed, in use, deep within the vessel of the hot water cylinder. The use of mains-rated voltage coils, for example, would necessitate a thermal fuse and wiring physically large enough to handle such high voltages. Similarly, the use of a thermal fuse to break (high) load-currents (rather that low coil currents) would also necessitate a large thermal fuse and wiring. In both such cases, the thermal fuse and wiring would be prohibitively large for placement inside the stem.

It should also be appreciated that embodiments of thermostats disclosed herein are also operational with either or both of AC and DC power supplies are connected. Furthermore, the safety features aspects provided thereby are also agnostic of (and are operational) whether the thermostat is powered from AC, DC, or both.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A thermostat comprising:
at least one set of input terminals for connecting an electric power source to the thermostat;
an output terminal for connecting the thermostat to a heating element;
a load switch for selectively connecting at least one of the set of input terminals to the output terminal and comprising an electromagnetic relay configured to interrupt electrical connection between the at least one set of input terminals and the output terminal when a coil of the load switch is de-energized;
a temperature sensor;
a controller circuit in communication with the temperature sensor and arranged to derive a temperature from a signal received from the temperature sensor, the controller circuit further being configured to selectively energize the coil of the load switch based on the derived temperature value in order to connect the at least one input terminal to the output terminal; and
a thermal fuse arranged to irreversibly de-energize the coil of the load switch when the thermal fuse is subjected to a temperature above a temperature threshold, thereby disconnecting a connection between the at least one set of input terminals and the output terminal.

2. The thermostat as claimed in claim 1, wherein the thermostat is a stem-type thermostat comprising a housing and an elongate hollow stem extending from the housing, wherein the temperature sensor and the thermal fuse are located internally to and near a distal end of the stem.

3. The thermostat as claimed in claim 1, wherein the at least one set of input terminals comprise a first set of input terminals for connecting a first electric power source to the thermostat, and wherein the thermostat further includes a first source switch comprising an electromagnetic relay having contacts interposed between the first set of input terminals and the contacts of the load switch, the first source switch being configured to interrupt the electrical connection between the first set of input terminals and the load switch when a coil of the first source switch is not energized, wherein the thermal fuse is arranged to irreversibly de-energize the load switch coil as well as the first source switch coil when the thermal fuse is subjected to a temperature above a temperature threshold, thereby causing the contacts of both the load switch and the first source switch to be returned to an open position, wherein the coil of the first source switch is rated for use with the same voltage as the coil of the load switch.

4. The thermostat as claimed in claim 3 wherein the first source switch has at least two co-operating switch contacts, such that energizing and de-energizing the coil of the first source switch respectively connects and disconnects all poles of the first set of input terminals from the first power source.

5. The thermostat as claimed in claim 3, wherein the at least one set of input terminals further comprise a second set of input terminals for connecting a second electrical power source to the thermostat, and wherein the thermostat further includes a second source switch comprising an electromagnetic relay configured to selectively connect either the contacts of the first source switch, or the second set of input terminals to the contacts of the load switch, the second source switch being arranged to connect the contacts of the first source switch to the contacts of the load switch when a coil of the second source switch is de-energized, and wherein the thermal fuse is arranged to irreversibly de-energize the load switch coil, the first source switch coil, and the second source switch coil when the thermal fuse is subjected to a temperature above a temperature threshold, wherein the coil of the second source switch is rated for use with the same voltage as that of the load switch.

6. The thermostat as claimed in claim 3, wherein the at least one set of input terminals further comprise a second set of input terminals for connecting a second electrical power source to the thermostat, and wherein the thermostat further includes a second source switch comprising an electromagnetic relay configured to selectively connect either the first set of input terminals, or the second set of input terminals to the contacts of the first source switch, the second source switch being arranged to connect the first set of input terminals to the contacts of the first source switch when a coil of the second source switch is de-energized, and wherein the thermal fuse is arranged to irreversibly de-energize the load switch coil, the first source switch coil, and the second source switch coil when the thermal fuse is subjected to a temperature above a temperature threshold, wherein the coil of the second source switch is rated for use with the same voltage as that of the load switch.

7. The thermostat as claimed in claim 5 wherein the first source switch is arranged such that energizing and de-energizing the coil of the first source switch respectively connects and disconnects all poles of the first set of input terminals from the first power source as well as all poles of the second set of input terminals from the second power source.

8. The thermostat as claimed in claim 5 further including a power supply unit arranged to output an energizing voltage corresponding to the voltage rating of the coils, the energizing voltage being obtained from either or both of the first power source and the second power source.

9. The thermostat as claimed in claim 5 wherein the controller circuit includes a power source selecting component arranged to selectively energize the coils of the first source switch and the second source switch, thereby to selectively connect either the first or the second power source to the contacts of the load switch.

10. The thermostat as claimed in claim 5 wherein the controller circuit further include an arc preventing component arranged to reduce or prevent arcing of the load switch contacts.

11. The thermostat as claimed in claim 10 wherein the arc preventing component includes an AC zero-crossing detecting component arranged to cause switching of the load switch contacts during or near the zero-crossing of the power source when an AC power source is selected by the power source selecting component.

12. The thermostat as claimed in claim 10 wherein the arc preventing component further includes a DC short-circuiting component arranged to momentarily short-circuit the power source before the load switch contacts are opened when a DC power source is selected by the power source selecting component.

13. The thermostat as claimed in claim 1 wherein the coil of the load switch is rated for use with a direct current voltage of 60V or less, or an alternating current voltage having an amplitude of 60V or less.
